(19) United States
(12) Patent Application Publication
(10) Pub. No.: US 2002/0035611 A1
(43) Pub. Date: Mar. 21, 2002

(54) System and method for providing an information network on the internet

(76) Inventor: Thomas P. Dooley, Vestavia Hills, AL (US)

Correspondence Address: Brobeck, Phleger & Harrison LLP, Intellectual Property Department, Suite 800, 1333 H Street, N.W., Washington, DC, 20005, US

(21) Appl. No.: 09/749,587

(22) Filed: Dec. 28, 2000

Related U.S. Application Data
(60) Provisional application No. 60/176,024, filed on Jan. 14, 2000.
(60) Provisional application No. 60/220,555, filed on Jul. 25, 2000.

(51) Int. Cl. G06F 15/16

(52) U.S. Cl. 709/218; 709/239

(57) ABSTRACT

A system and method for providing an information network on the Internet is provided. The system includes a plurality of websites and at least one redirect assigned to each website. The websites each include a category, information about the category and a domain name that corresponds to the category. The redirect includes a URL redirect that directs a browser or a server to the assigned website. The method includes the steps of: (1) providing a plurality of websites; (2) providing each website with a category, information about the category, and a domain name that corresponds to the category; (3) providing at least one redirect assigned to each website; and (4) providing each redirect with a URL redirect that directs at least one of a browser and a server to the assigned website.

### CROSS-REFERENCE TO RELATED APPLICATIONS

The present invention claims the benefit of U.S. Provisional Patent application No. 60/176,024, filed Jan. 14, 2000, and U.S. Provisional Patent application No. 60/220,555, filed Jul. 25, 2000, the disclosures of which are hereby incorporated by reference in their entireties.

### BACKGROUND OF THE INVENTION

1. Field of the Invention

The present invention relates generally to the organization of information on the Internet. Specifically, the present invention is directed to a system and method for providing an information network on the Internet.

2. Description of the Related Art

In order to provide Internet users with information related to field or an industry, or to offer products or services to users, Internet websites or webpages may be established. Conventional attempts to establish such a presence on the Internet are generally limited to a single website using a single registered domain name. A single website may include a plurality of webpages that may be viewed by web browser software (e.g., Netscape Navigator®) run on a computer connected to the Internet.

Various search engines, that is, websites that specialize in generating lists of websites and webpages corresponding to a user input (e.g., a search request, a search term, etc.), exist on the Internet. Search engines assist an Internet user in locating the desired information, and providing a link (e.g., a hyperlink) to the desired information on various remote sources, such as websites and webpages, that correspond to the topic of interest.

A conventional single registered domain name may correspond to only one of many predictable search terms that a user may enter into a search engine. Many users may not be able to locate the conventional single website if the user enters a search term that is different from the single domain name of the website or its content, although the search term may have a similar meaning. Conventional single websites may also be problematic in that even if a user locates a website that includes some information related to the request, in order to locate additional information that is not present on that website, the user generally must return to the search engine results, or perform additional searching.

Rapid growth in the number of registered domain names, websites, and webpages has resulted in intensified competition among websites and webpages to obtain a high ranking from search engines. A high ranking generally increases the likelihood that a particular website or webpage will be observed, and preferably chosen, by a user. At this juncture, it is very common for search engines to identify thousands, or millions, of individual websites or webpages as the result of a single search query. Users are unlikely to peruse the search results list in detail, and thus often view only the highest-ranking results of the search. For instance, it is common for a user to be presented only the first, or highest level, group of results, which typically includes only the top 10 results. To view additional results, the user must request the second group of results, which may take additional time to view all subsequent groups of results. Therefore, if a single website, representing a single registered domain name, does not appear at or near the top of the search results list, it is seldom viewed by a user. Thus, a high ranking in search engine results increases the likelihood of a website being viewed and the link selected by a user.

In view of the intensified competition on the Internet, search engines and the companies supporting them have adopted a variety of strategies to determine placement of websites or webpages offered in a search. Some search engine companies have developed computer software algorithms that identify “desirable” features within websites or webpages to increase the likelihood of high level placement. Examples include: the number of representative keywords within the content, the number of hyperlinks, the presence of metatag data, and the presence of the search term or a closely related term within the domain name, etc. Search engine algorithms, strategies, and differential “weightings” for each characteristic vary between search engine vendors. In addition, some search engine vendors charge a fee to ensure that a website is included within their data banks and/or has a higher ranking in the search results.

In view of these factors, the conventional single website (and single domain name) is often not capable of driving high volume Internet traffic. Thus, the single website is more likely to require conventional branding and advertising, which can be very expensive, in order to drive high volume Internet traffic. Some website owners simply chose to pay a fee to a third party vendor of Internet traffic in order to drive traffic to their site(s), often a relatively high cost. Without receiving traffic, the information, products, or services of a website will not be accessed and used, and are of little value to the website owner. It is highly desirable to obtain high volume traffic at the least cost per visitor. Yet, many websites at present are not likely to accomplish this objective, without a distinctive competitive or innovative advantage.

### SUMMARY OF THE INVENTION

Therefore, a need has arisen for a system and method for providing an information network on the Internet that overcomes these and other drawbacks of the related art.

As embodied and broadly described herein, the present disclosure is directed to an information network over the Internet. The information network's features are fully enabling to generate high volume Internet traffic, including eyeballs (e.g., the number of users who see a website or webpage) and stickiness (e.g., the length of visit time to a website or websites), by users seeking information about topics, products, and services.

In one embodiment, the network may be hierarchical, consisting of numerous categories and subcategories in a particular field, such as the healthcare field. All of these categories of potential websites are available for partnering or advertising from third parties on “neutral” websites not operated by a single, large, industry-dominating company who produces the actual products or services.

According to one embodiment of the present invention, a system for providing an information network on the Internet is disclosed. The system includes a plurality of websites and at least one redirect assigned to each website. The websites each include a category, information about the category and a domain name that corresponds to the category. The redirect includes a URL redirect that directs a browser or a server to the assigned website.

According to one embodiment of the present invention, a method for providing an information network on the Internet is disclosed. The method includes the steps of: (1) providing a plurality of websites; (2) providing each website with a category, information about the category, and a domain name that corresponds to the category; (3) providing at least one redirect assigned to each website; and (4) providing each redirect with a URL redirect that directs at least one of a browser and a server to the assigned website.

According to another embodiment of the present invention, a method for enhancing a probability of high placement of a webpage by a search engine is provided. The method includes the steps of (1) providing the website with a plurality of links; (2) providing the website with a domain name corresponding to a category of the website; and (3) providing the website with content containing key words related to the category.

It is a technical advantage of the present invention to provide an information network having a plurality of registered, owned, or leased member domain names. It is a technical advantage of the present invention to provide the domain names as simple descriptive terms that are broadly representative of a field, category, or subcategory. It is another technical advantage of the present invention to provide a plurality of websites. It is another technical advantage to provide websites that contain content related to a field, category, or subcategory. It is another technical advantage of the present invention to provide a plurality of internal links (e.g., hyperlinks) among the member websites. It is another technical advantage of the present invention to provide a plurality of URL redirects from domain names within the network, that are not in use as websites, into content-containing websites. It is another technical advantage of the present invention to provide URL redirects into the network from websites or domain names outside of the network, whether or not registered, owned, or leased by the owners of the network. It is another technical advantage of the present invention to increase the likelihood that member websites receive high rankings from Internet search engines. It is another technical advantage of the present invention to provide a search engine, either internal or external to the network, which will provide either exclusive or high level placement of network member websites in search results. It is yet another technical advantage of the present invention to increase the potential of obtaining high volume Internet traffic without requiring conventional branding, advertising, or promotional methods to drive traffic into the network. It is another technical advantage to provide a cost-effective method to establish or promote brands or hyper-brands (e.g., for corporations, products, services, etc.) by generating high volume traffic online. It is another technical advantage of the present invention to provide information, products, and/or services relating to a field, category, or sub-category, so that it may be made available to users over the Internet. It is another technical advantage of the present invention to annex and/or hyperlink together a plurality of networks or sub-networks (e.g., fields, categories, and/or subcategories) to generate additive or synergistic traffic within the network. It is another technical advantage of the present invention to generate high volume Internet traffic through the establishment of matrices of individual components, including but not limited to a plurality of domain names, websites, webpages, URL redirects, hyperlinks, and internal and/or external search engines. It is another technical advantage of the present invention to arrange the websites, webpages, domain names, and other information into hierarchical relationships. It is another technical advantage of the present invention to provide directories or site maps of hierarchical relationships among components. It is another technical advantage of the present invention to provide directories online as an alternative to and/or in addition to external search engine-based directories. It is another technical advantage of the present invention to utilize the network as a business model, for use by or in connection with commercial for-profit, not-for-profit, institutional, educational, governmental, and other entities.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a general purpose computing system;

FIG. 2 depicts a structure for an information network according to one embodiment of the present invention; and

FIG. 3 depicts an information network in relation to an Internet user according to one embodiment of the present invention.

### DETAILED DESCRIPTION OF THE INVENTION

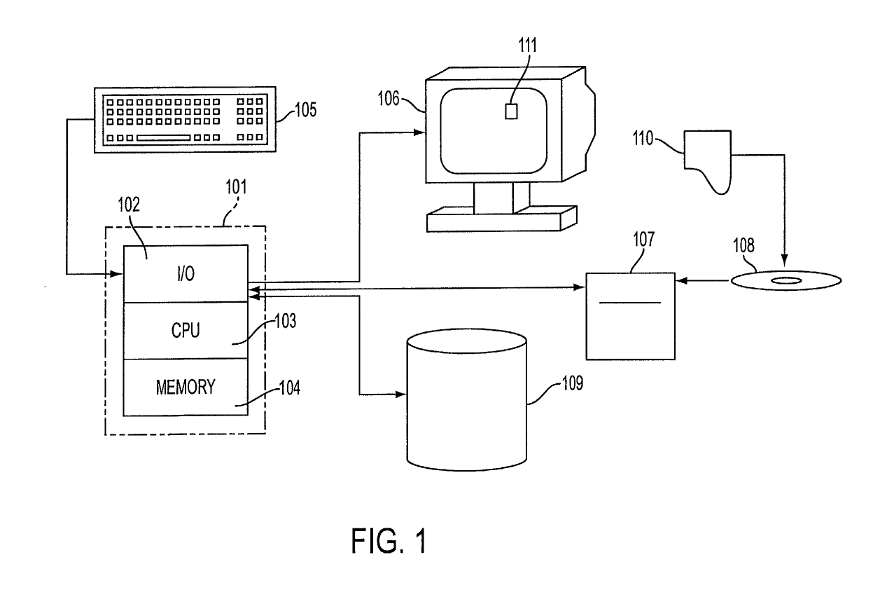

The preferred embodiment of the present invention and its advantages are best understood by referring to FIGS. 1 through 3 of the drawings, like numerals being used for like and corresponding parts of the various drawings.

The environment in which the present invention may be practiced encompasses general distributed computing system, wherein general purpose computers, workstations, or personal computers are connected via communication links of various types, in a client-server arrangement. Programs and data, many in the form of objects, may be made available for execution and access. Some of the elements of a general purpose workstation computer are shown in FIG. 1, wherein processor 101 is shown, having input/output section 102, central processing unit 103, and memory section 104. Input/output section 102 may be connected to keyboard 105, display unit 106, disk storage unit 109, and CD-ROM drive unit 107. CD-ROM unit 107 can read a CD-ROM medium 108, which typically contains programs and data 110. In one embodiment, the general purpose computer may lack some or all of the features described above. For example, the general purpose computer may operate as a terminal, an emulator, etc. with Internet access.

As used herein, the term “field” may include an industry, a discipline, a topic, or a particular area of interest. Although the present invention is sometimes described herein in conjunction with the healthcare and biomedical research fields, it should be noted that the present invention is not so limited. For example, the information network of the present invention may be used in many fields, including transportation, music, entertainment, sports, travel, legal, education, hobbies, manufacturing, media and promotions, computer information, technology, skincare, religion, children, finance, recreation, business information, research, history, etc.

Each field may include several categories. For example, in the healthcare field, categories may include women's health, dermatology, oncology, urology, etc. In the transportation field, categories may include freight, trains, trucks, airplanes, etc. In the music field, categories may include tapes, videos, CDs, musical instruments, concerts, etc. In addition, each category may include subcategories, and those subcategories may have subcategories, etc. The number of fields, categories, and subcategories may vary depending on the number of levels provided. Other fields, categories, and subcategories not specifically mentioned are contemplated by the present invention.

It should be noted that, although the terms “field,” “category,” and “subcategory” have been identified above, other hierarchies and structures are within the contemplation of the present invention.

The information network of the present invention may include a plurality of internal links within the website to other websites within the network. Not only may multiple hyperlinks into a website drive traffic into it, but multiple hyperlinks within a website are likely to be weighted (favorably) by some Internet search engine algorithms, because a website that contains a plurality of hyperlinks (websites, webpages, or domains, especially those linking into the website) appears to be fully developed and resembles a “portal” into a well-connected network website. In addition, the information network may provide high volume traffic, due to synergy of the information network with a plurality of websites, domain names, and URL redirects, such that the traffic volume may be positively recognized and weighted favorably by some Internet search engines. These features will be discussed in greater detail, below.

The information network of the present invention may include a plurality of internal links within the website to other websites within the network. Not only may multiple hyperlinks into a website drive traffic into it, but multiple hyperlinks within a website are likely to be heavily weighted (i.e., favorably) by Internet search engine algorithms, because a website that contains a plurality of hyperlinks (websites, webpages, or domains, especially those linking into the website) appears to be fully developed and resembles a “portal” into a well-connected network website. In addition, the information network provides high volume traffic, due to synergy of the information network with a plurality of websites, domain names, and URL redirects, which may be positively recognized by some Internet search engines. These features will be discussed in greater detail, below.

As discussed above, the information network of the present invention may include websites (“member websites”) having domain names including term(s) that are likely to be entered as search terms by users interested in a particular field, category, or subcategory. Each domain name may be descriptive of some feature of a selected field, category, or subcategory. By using simple, descriptive terms, a domain name can indicate some or all of the contents of its webpage. Multiple top-level domains (e.g.,.com, net, org, .edu, .tv, etc.) may be used with the present invention. In one embodiment, when a choice exists, preference may be given to the .com, or secondarily to the net top level domains, as these are commonly perceived as preferred and/or premier domain name suffixes over less preferred domains, such as org, .tv, etc. In addition, if a user directly types in a domain name with the correct syntax into a web browser, it is more likely that the user will attempt this link using either the .com or secondarily net top level domains, rather than with some other suffix.

The domain names may include a single term, multiple terms, or multiple concatenated terms that are separated by a hyphen. In one embodiment, the letter “e,” the letter “i,” or any other letter(s) may precede the term(s), and may be separated from the term(s) by a hyphen. The domain names may be lacking trademark, service mark, or brand name potential, or in some instance the domain names may be terms, which are or may become trademarks, service marks, or brand names. Although it is preferred to use simple descriptive domain name terms, other conventions may be used as desired in selecting domain names.

The multiple domain names may be “mined” online from domain name databases to determine which appropriate names are available (i.e., either not registered or available for purchase or lease from another party). Then, the selected domain names may be registered (for instance, from Network Solutions, Inc.), purchased, and/or leased from the current owner. This collection of possessed domain names may create a virtual “lexicon” of terms related to a particular field or sub-field (e.g., category or subcategory).

The domain names (registered, owned, and/or leased) may be deployed as websites with links to other websites in the information network. This virtual “lexicon” of related terms (i.e., using the domain names and websites utilizing some or all of the domain names) may be deployed in hierarchical categories representative of the field, category, or subcategory. For example, in a healthcare information network with a category focusing on skincare and dermatology, domain names including specific terms for dermatological conditions, such as skin cancer (e.g., skin-cancers.net, melanoma.net), sunburns (e.g., sunburns.net), erythema (erythema.com), etc. may be used. The domain names may also include general medical terms like drug treatments, therapies, or product names (e.g., acne-drug.com, corticosteroid.com, e-minoxidil.com). The names may also include medical professionals and other experts (e.g., e-cosmetologists.com, beauty-consultants.net, estheticians.org, webdermatologists.com).

In one embodiment, the domain names may be selected in accordance with a particular language, or dialect, of a particular area. For example, for users in the United States and United Kingdom, the domain names may include English words. In France, the domain names may include French words.

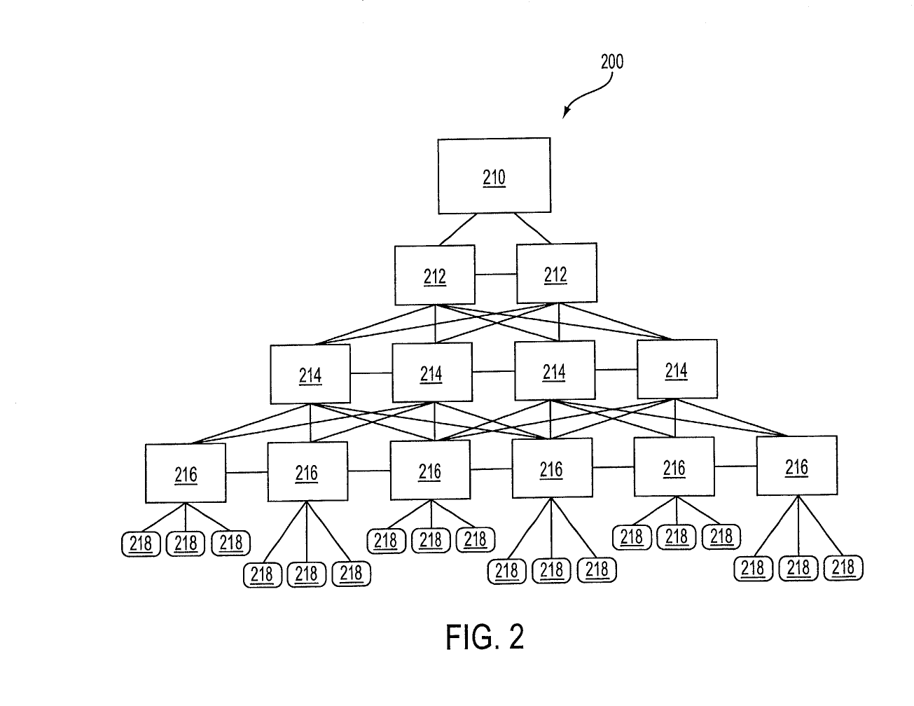

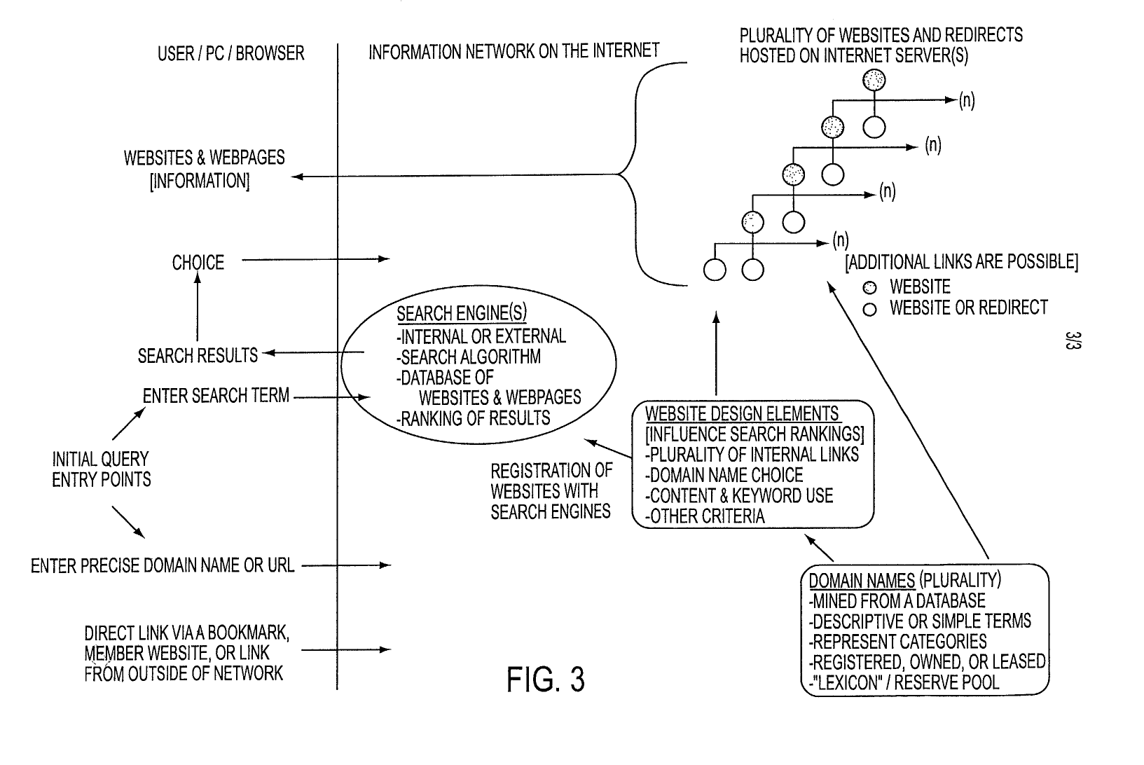

The information network of the present invention may have a hierarchical structure. Referring now to FIG. 2, a structure for an information network according to one embodiment of the present invention is provided. Information network 200 includes a plurality of websites 210, 212, 214, 216, and 218 at multiple levels. The number of levels may vary; in the embodiment that is described, five levels are provided. Additional, or fewer, levels may be provided as necessary. According to another embodiment, the structure of an information network may be graphically depicted as in FIG. 3, which will be discussed in greater detail, below.

Referring again to FIG. 2, host website 210 may be a website that lists a plurality of network websites 212, and may provide a hyperlink to each network website 212. In addition, host website 210 may provide links to subordinate websites. For example, host level website 210 may represent the entity that owns information network 200, and may include links to network websites 212, each of which may represent a field.

In general, a “network” refers to a collection of websites that are related to a single field. Each network website 212 may include an index of the respective network's subordinate websites, including its system websites 214. Each system website 214 may represent a category of the field of its respective network website 212. For example, in the case of a healthcare information network, network website 212 may represent the field of healthcare, while system websites 214 may represent categories such as medical disciplines (e.g., dermatology, oncology, gynecology, etc.). In addition, system websites 214 may include hyperlinks to at least one entry website 216.

Entry websites 216 may include general, useful information to users for a particular subcategory of the category of its respective system website 214. This information may be provided at a basic level, or it may be provided at a higher or a lower level. In one embodiment, the content may be prepared by professional staff, scientists, and/or consultants. In another embodiment, the content may be provided, or supplemented, by users.

In one embodiment, promotional webpage elements or webpages (not shown) may be provided for the user. These promotional pages may contain advertisements, coupons, etc. in order to support product decision-making. Examples of webpage elements may include, but are not limited to buttons, banners, logos, graphic designs, streaming video, streaming audio, rich text, etc. Other information may be provided to the user as desired in attempts to promote or advertise products or services.

Entry websites 216 may also include links to system websites 214, network websites 212, and/or host websites 210, as well as other relevant sites to facilitate the location and retrieval of related content. For example, in a healthcare information network, entry websites 216 may link to educational websites, information websites, advertising websites, coupon websites, doctor finder websites, sales websites, support group websites, products, services, as well as websites for other related companies or organizations, such as the National Institute of Health.

A plurality of redirect 218 may be provided for each entry website 216. In general, redirects serve to direct, or route, traffic from redirect websites or domain names to the corresponding entry website 216. In one embodiment, redirects 218 may be active domain names on a server, but may not contain websites or webpages. In another embodiment, redirects 218 may contain websites with minimal information or content, or may be complete websites.

Redirects 218 may contain embedded metatags of important keywords related to the subcategory it represents. In another embodiment, redirects 218 may be fully operational websites with content within information network 200, or may be operated by a third party “outside” of information network 200, which is permitted to hyperlink into information network 200. In one embodiment, when redirect 218 is accessed, a web browser may be directed to the appropriate entry website 216, system website 214, network website 212, or host website 210 at the discretion of the webmaster overseeing the hosting server. This may be automatic, or it may require user interaction.

In another embodiment, a server may be directed to the appropriate entry website 216, system website 214, network website 212, or host website 210.

Each entry website 216 with its related redirects 218 may resemble a “grape cluster” of related terms, representative of a category of information, either in whole or in part. All of the associated “grape clusters” may be interrelated into a “grape vine,” with the entire network assigned a specific name (for example, in healthcare, companybiomedical.net; in legal, companylegal.net, etc.). Each “grape cluster” may appear as a subsidiary to its hierarchical superior categories. Scalability may be accomplished by annexing additional websites or “grape clusters” for new topic areas, and by annexing additional higher level websites, such as network websites 212 and system websites 214 for entire industries or subordinate categories.

Some, or all, of the websites, including host level website 210, network websites 212, system websites 214, entry websites 216, and redirects 218 may be registered with search engines, and may be directly identified by users. Given the increased number of registered websites at the lower levels, especially entry websites 216, a plurality of “targets” are provided for discovery by search engines, and thus by the users.

In one embodiment, a search engine (not shown) may be provided for information network 200. The search engine may be internal to information network 200, or it may be external to information network 200. By definition, an internal search engine provides exclusive or enriched information or links to the information with the network's member websites (and/or those of partner websites), in order to enhance the user's ability to find information preferentially within the network as opposed to within all of the Internet. An example of commercially available search engine software code is Search Maker Pro (available from SearchMakerPro.com.

The search engine of the present invention may include a database of relevant network websites. For example, in one embodiment of the present invention, the search engine may include a database containing information on all entry websites 216 and/or higher level websites. The database may include the domain name, as well as related content terms and metatags for each entry website 216. The user may enter a search term, or terms, and the search engine may query the database to locate related entry website(s) 216, and return the list of entry website(s) 216 with a hyperlink. Other methods for internal searching may be provided.

As discussed above, the search engine may be hosted “outside” of, or external to, information network 200 and its hosting facilities.

In one embodiment, the search engine may include a parsing feature that permits searching of concatenated (two or more words) or hyphenated domain names. For example, without a parsing feature, the domain name “hairstimulant.com” may not be recognized as having two discrete terms, hair and stimulant. Search engine software codes with parsing capabilities are currently available, and may be used in this invention (e.g., ConnectPal or DocFather Java applets).

Referring to FIG. 3, a graphical representation of an example of an information network on the Internet in relation to the user seeking information according to one embodiment of the present invention is provided. This depiction portrays the system, the methods used to develop the system, and selected advantages of the system and methods.

The figure depicts a user/PC/browser side and information network side. A user may gain access to the information network in a variety of manners. FIG. 3 demonstrates some of the likely routes by which an Internet user may access the information network on the Internet. In one embodiment, a user may directly enter the precise domain name or URL of a member website or member domain name into a browser on the user's personal computer. The user may also access a conventional search engine or browser (e.g., google.com, yahoo.com, netscape.com, northernlight.com, etc.) and enter a search request (i.e., term or terms). The search engine may identify relevant websites that have been registered with or located by the particular search engine, and may return this search results list to the user. Once the search results are returned, the user may make a choice and select (or “click”) a particular search result and be hyperlinked to the selected website in accordance with the operation of the search engine.

If the user selects a redirect (e.g., redirect 218 in FIG. 2), the user may be automatically hyperlinked to the corresponding entry website for the redirect (or possibly a higher lever at the discretion of the system administrator). In another embodiment, the user may be required to select the hyperlink in order to access the corresponding entry website. If the user selects an entry website using a browser or search engine, the user may be hyperlinked to the entry website.

In another embodiment, the user working within information network 200 may use the search engine or an internal site map for all or a portion of information network 200 to locate the desired information.

In one embodiment, a search engine may be deployed on the Internet “outside” of ,or external to, information network 200, and thus be available to all users of the Internet, regardless of whether the user intends to search for terms representative of websites or webpages controlled by information network 200. This search engine may provide high level or exclusive placement of all of information network 200's websites in any of the appropriate categories for which websites have been prepared, or for which URL redirect traffic is desirable. This search engine may be a direct competitor to other search engines or browsers on the Internet, such as google.com.

In still another embodiment, the user may start at host website 210, or a lower level, and navigate through information network 200 to locate the desired information via hyperlinks.

The websites of the information network may be hyperlinked to generate collateral traffic (both eyeballs and stickiness) in a large matrix including all or portions of information network 200, as depicted in FIG. 2. This internal traffic may generate high numbers of hits and pages served. Within the websites of information network 200, the user may be presented with suggested choices and/or a decision tree of choices to help guide the decision-making processes. For example, in a healthcare information network, information network 200 may distinguish among diseases, anatomy, and therapeutic options, such as prescription drugs, over-the-counter drugs, and cosmetics. The information can note that cosmetics, unlike drugs, are exempt from stringent FDA approval. In one embodiment, a user may be able to access information about the FDA, the approval process, pharmaceutical research, either generally or as it specifically applies to the product in question. The user may also be able to retrieve the status of a product in question.

In one embodiment, a combination of elements or features of the website(s) design (either alone or in conjunction with features or elements of the information network) may be utilized to enhance high level placement of the member websites or webpages within search engine's results. Examples of representative website design elements are included in FIG. 3. In one embodiment, enhanced placement may be affected by the plurality of internal links between member websites, both into and out of the website. It may be especially advantageous for a website to be linked into from other domains, websites, or webpages. The plurality of domain names and websites in the network may provide a “captive” pool of potential links into a given website, some or all of which may contain content directly related to the content of the given website to which it is linked. In another embodiment enhanced placement may be affected by providing a linked site map to all other websites. In another embodiment enhanced placement may be affected by the choice of domain name(s) and the use of simple descriptive keywords or terms within the selected domain name(s). The probability that a user may select (for searching or direct entry into a browser) a simple descriptive term is greater than a complicated, abstract, or synthetic term. In one embodiment, enhanced placement may be affected by including content within the website that contains information and representative keywords related to the topic specified by the domain name. In one embodiment, enhanced placement may be affected by registration of website URLs with Internet search engines or brokers on their behalf. In one embodiment, enhanced placement may be affected by including embedded metatag data into the website(s), although not all search engines place priority weighting on this feature. In one embodiment, enhanced placement may be affected by search engines recognition of established high volume traffic into a given website, regardless of how that traffic was generated. In another embodiment, enhanced placement may be attained by the inclusion of a variety of additional software code elements (e.g., Java applets, cookies, and other elements) within the website(s) design, which may be weighted favorably by search engines. In another embodiment, enhanced and/or optimized placement within search engine results may be affected by all or a subset of the website design element embodiments listed above (e.g., plurality of links, use of simple descriptive domain names, content with keywords, registration with search engines, embedded metatags, etc.). The plurality of these web design features may provide additional or synergistic traffic into and within the member websites of the information network.

In one embodiment, participants who visit the website(s) may be required to register prior to accessing some content in order for the network to obtain some identifying, or registration information (e.g., a user name, an e-mail address, a mailing address, a URL, a password, IP address, etc.) and/or demographic information (e.g., sex, age, geographic region, purchasing preferences, etc.). This information may be provided to help guide a user's journey within the information network. In another embodiment, artificial intelligence software code may be used to further customize and/or personalize a user's session, and assist with the user's most likely questions and “surfing” routes within the information network.

The user may benefit from having access to a plurality of product and service vendors in a “single” location on the web (i.e., within the information network). This will save the user time from locating multiple individual websites outside of the network. In one embodiment, the domain names may be hosted at a single physical facility on servers connected to high bandwidth, redundant Internet access, which supports rapid high volume traffic. Having all sites hosted on the same server rack may facilitate fast links between the individual components of the system. The hardware may allow links to open as quickly as individual pages would routinely open within a single website. In essence, the entire linking processes may occur rapidly on a single physical rack within the system, although it is also possible to deploy the system in multiple remote server sites.

In one embodiment, the information network may be utilized as a business model, for use by and in connection with commercial for-profit, not-for-profit, institutional, educational, governmental, and other entities. The business model may offer to users a plurality of topics in a field (e.g., an industry or discipline) within the websites and/or webpages. The websites and/or webpages may inform and/or promote products and/or services of potential interest to the user. In one embodiment, the information network may be used to generate income or revenues from strategic alliance partners, advertising, licensing or sub-licensing of the technology, among other strategic or tactical options. In another embodiment, the information network owner may utilize the technology to obtain equity, stock, units, investments, or other non-cash forms of compensation from alliance partners, firms, or individuals.

In one embodiment, the present invention may abrogate the dogma “rules” of conventional advertising. Conventional advertising dogma states that in order to promote a company, product, or service, one must generally fulfill two key “rules” in the marketplace, the establishment of a brand (or hyper-brand), and reinforcement of the brand by conventional advertising. Either of these rules may be very expensive for a vendor of information, products, and/or services. In another embodiment, the network of the present invention may not require branding and/or additional conventional advertising in order to promote the information network. This is in part due to the heightened potential for discovery of the network websites by search engines, in view of the advantages posed by the plurality of domain names and websites within the matrix (as mentioned above). Therefore, additional conventional advertising (e.g., print media, television, radio, etc.) may not be necessary to attract visitors and to generate high volume traffic. This system provides an interesting and more affordable paradox as an information system business model; it may serve as an “advertiser” to generate income from posting other companies' advertisements within the network's websites, yet the network itself does not require advertising or branding to promote itself. In essence, the network becomes an advertiser for other partners or even potential competitors. Nevertheless, conventional advertising may be used if desirable to complement the traffic generated in its absence. In another embodiment, generation of high level traffic within the information network may help establish or promote brands or hyper-brands (e.g., for companies, products, services, etc.).

In one embodiment, mirror websites may be provided. Given a plurality of related terms within an industry as domain names, one may essentially duplicate the information from one website with domain name “a” with a very similar site having the alternative domain name “b.” When this second “b” site is registered with a search engine, it may be perceived as a novel website. Establishment of mirror websites may increase the number of perceived websites on the Internet, without requiring the creation of additional content. For instance, one website may use the “singular” category designation and another similar website may use the “plural” category designation within the domain name. This method may increase the likelihood of discovery of the information by users utilizing search engines, especially in the case where search engines uses strict or precise spelling/syntax features within the algorithms.

In one embodiment of the present invention, the information network of the present invention may also preserve anonymity of the user who accesses the information network. In another embodiment, the user may have the option to use a secure connection in accessing the information network of the present invention. In yet another embodiment, the information network may include content restriction features, such as child protection features, to restrict the content that a user may access. This may include completely restricting certain websites or webpages, or restricting images or video on a website.

The present invention may also include a forum, such as bulletin boards, chat rooms, etc. for users to post messages, questions, hyperlinks, etc. In one embodiment, certain users may be able to submit information to the information network that may be posted at the discretion of the system administrator. For example, in a healthcare information network, doctors may submit observations and feedback about a particular drug to the information network. The information network may maintain a tally of authorized submissions for posting to users.

In another embodiment, the network may collect information on traffic, hits, webpages, referring traffic, unique IP addresses, demographic information, for the purposes of enhancing subsequent reorganization of the hyperlinks within the system. For instance, the highest-level traffic websites may be used to drive traffic to less utilized portions of the network. This may be accomplished by placing links to the low volume websites prominently within the high volume websites. In another embodiment, this collected information may be used strategically to generate revenues from advertisers, who may wish to know particular characteristics about volume, traffic patterns, or other information.

In one embodiment, the information network of the present information may be deployed by a single entity. This entity may include individuals, companies, corporations, partnerships, agencies, institutions, governments, societies, organizations, etc. In another embodiment, the present invention may be deployed by a single entity in connection with other entities.

In one embodiment, the information network invention may generate high volume Internet traffic as a result of the combination of the plurality of advantageous features described above, and as depicted graphically in FIG. 3 as an example. The major groupings of advantageous features of the information network of the present invention include, but are not limited to domain name selection criteria, plurality of domain names, website design elements, plurality of websites, registration of websites with search engines, criteria to enhanced placement of websites in search engine results, plurality of hyperlinks within and into the information network, the relationships of links between each website (e.g., hierarchical, matrices, etc.), plurality of redirects, and providing the user with information within the category related to the user's query search terms, etc. The combination of some or all of these features deployed within the information network invention overcome the disadvantages inherent in the related art (e.g., single webpage with a single domain name).

### EXAMPLE

In order to better understand the present invention, an example is provided. The example does not limit the present invention in any way, and is intended to illustrate an embodiment of the present invention.

According to one embodiment of the present invention, a healthcare information network is provided. The healthcare information network includes a hierarchical series of Internet domain names and websites (and in some instances trademarks and service marks) that are representative of the healthcare and biomedical research industries. The present invention allows for an information network and/or a business model for medical and biomedical research companies or institutions (e.g. medical, dental, biotechnology, pharmaceutical, etc.) that may be arranged as a hierarchical series of Internet domain names preferably containing simple descriptive terms, and top-level domain name suffixes (.com, net, org, .edu, .tv, etc.), and associated trademarks and service marks, which are networked over the worldwide web into a source for specific medical and biomedical disciplines (e.g., dermatology, cell biology, etc.) for the purposes of providing information, marketing, promotion, advertising, e-commerce, products, sales, services, physician referrals, chat rooms, expert opinions, libraries or lexicons of information, among other possibilities.

In the medical specialty of dermatology (subordinate to the medical or biomedical level(s) of the information network), categories may include for instance: dermatologists and other experts, diseases, anatomy, pathologies, products, services, drugs, cosmetics, cosmeceuticals, devices, dermatology research, conferences, general information, training, technologies, among other possibilities. By way of example, the “dermatology” discipline and its subordinate domains may appear at and below the level 214 of FIG. 2, although this position is not required.

The following table provides a limited example of domain names that may be used in the dermatology discipline (including skincare and cosmetics). Additional domain names may be provided. Each domain name would have an appropriate top-level domain designation (e.g., .com, net, org, .edu, .tv, etc.) as a suffix.

| “Category” | Domain Name |
|---|---|
| Geographic | dermuniverse |
| | dermatologyworld |
| | earthderm |
| | skinworld |
| | globaldermatology |
| | europederm |
| | ukderm |
| | asiaderm |
| | japanderm |
| | usaderm |
| | usa-derm |
| | dermalabama |
| Experts | webdermatologists |
| | dermatology-surgeon |
| | e-dermatologists |
| | e-estheticians |
| | e-cosmeticians |
| | e-cosmetologists |
| | e-beautyconsultant |
| | cosmeticchemists |
| Information | skin-information |
| | derm-information |
| | dermdictionary |
| | dermlexicon |
| | e-lexicons |
| | cosmetic-information |
| | dermserver |
| Diseases | skin-disease |
| | skin-problem |
| | skin-cancers |
| | e-baldness |
| | allergy-info |
| | erythema |
| | pemphigus |
| | ichthyosis |
| | rashes |
| | hives |
| | hairless |
| | i-dermatitis |
| | e-eczema |
| | i-psoriasis |
| Anatomical & Cell Types | e-dermal |
| | e-dermatologic |
| | dermatologic |
| | dermatological |
| | cutaneous |
| | epithelial |
| | e-epidermal |
| | keratinocytes |
| | melanocyte |
| | fibroblast |
| | adipocytes |
| | lymphocyte |
| | macrophages |
| | e-neurons |
| Products & Services | dermatology-research |
| | dermatology-products |
| | dermproducts |
| | dermsystem |
| | dermservices |
| | dermsupplies |
| | dermdevices |
| | skincare-product |
| | beauty-products |
| | perfume-products |
| | cosmeticproducts |
| | cosmetic-supplies |
| | coupon-ads |
| | selling-domain |
| Pharmaceuticals & Cosmetics | otc-drug |
| | rx-drug |
| | dermdrugs |
| | topicals |
| | cosmeceuticals |
| | cosmeticsanddrugs |
| | cosmetics-drugs |
| | drugsandcosmetics |
| | allergy-drug |
| | allergy-therapies |
| | acne-drug |
| | psoriasistherapy |
| | e-minoxidil |
| | corticosteroid |
| | nsaid |
| | keratolytic |
| | e-antioxidant |
| | e-antiinflammatory |
| | retinoids |
| | skinlightener |
| | sunscreens |
| | e-deodorant |

Other embodiments and uses of the invention will be apparent to those skilled in the art from consideration of the specification and practice of the invention disclosed herein. All references cited herein, including all U.S. and foreign patents and patent applications, are specifically and entirely hereby incorporated herein by reference. It is intended that the specification and examples be considered exemplary only, with the true scope and spirit of the invention indicated by the following claims.

I claim:

1. A system for providing an information network on the Internet, comprising:
a plurality of websites, each website comprising a category, information about the category and a domain name that corresponds to the category; and
at least one redirect assigned to each website, each redirect comprising a URL redirect that directs at least one of a browser and a server to the assigned website.

2. The system of claim 1, wherein the redirect further comprises at least one of a redirect domain name, a website, and a webpage.

3. The system of claim 1, wherein each of the websites further comprise at least one webpage.

4. The system of claim 1, wherein the domain name comprises:
a top-level domain; and
at least one of a descriptive term, a simple term, and an abbreviation corresponding to the category.

5. The system of claim 4, wherein the domain name further comprises at least one of a hyphen, a prefix, and a suffix.

6. The system of claim 5, wherein the prefix or suffix is selected from the group consisting of a letter, a term, and a number.

7. The system of claim 2, wherein the redirect domain name comprises:
a top-level domain; and
at least one of a descriptive term, a simple term, and an abbreviation corresponding to the category.

8. The system of claim 7, wherein the redirect domain name further comprises at least one of a hyphen, a prefix, and a suffix.

9. The system of claim 7, wherein the prefix or suffix is selected from the group consisting of a letter, a term, and a number.

10. The system of claim 1, wherein the websites contain a plurality of links.

11. The system of claim 10, wherein the links are internal to the information network.

12. The system of claim 10, wherein the links originate from outside the information network.

13. The system of claim 1, further comprising:
a search engine.

14. The system of claim 1, wherein the information network is a healthcare information network.

15. The system of claim 1, wherein the information network is a biomedical information network.

16. The system of claim 1, wherein the website further comprises at least one of promotional information and advertising information.

17. The system of claim 1, wherein the website further comprises at least one of product information and service information.

18. The system of claim 1, further comprising:
at least one information directory comprising at least one of a site map and a plurality of links to the websites.

19. The system of claim 1, wherein the websites and domain names are arranged in a hierarchical structure.

20. The system of claim 1, further comprising:
at least one matrix of information.

21. The system of claim 1, wherein the information network is deployed by a single entity.

22. The system of claim 1, wherein the information network is deployed by a single entity and at least one additional entity.

23. The system of claim 1, further comprising:
at least one unused domain name.

24. The system of claim 1, further comprising:
at least one mirror website.

25. A method for providing an information network on the Internet, comprising:
providing a plurality of websites;
providing each website with a category, information about the category, and a domain name that corresponds to the category;
providing at least one redirect assigned to each website; and
providing each redirect with a URL redirect that directs at least one of a browser and a server to the assigned website.

26. The method of claim 25, further comprising the step of:
providing the redirect with at least one of a redirect domain name, a website, and a webpage.

27. The method of claim 25, further comprising the step of:
providing each of the websites with at least one webpage.

28. The method of claim 25, wherein the step of providing each website with a category, information about the category, and a domain name that corresponds to the category comprises:
providing the domain name with a top-level domain; and
providing the domain name with at least one of a descriptive term, a simple term, and an abbreviation corresponding to the category.

29. The method of claim 28, farther comprising the step of:
providing the domain name with at least one of a hyphen, a prefix, and a suffix.

30. The method of claim 28, wherein the prefix or suffix is selected from the group consisting of a letter, a term, and a number.

31. The method of claim 26, wherein the step of providing the redirect with at least one of a redirect domain name, a website, and a webpage comprises:
providing the redirect domain name with a top-level domain; and
providing the redirect domain name with at least one of a descriptive term, a simple term, and an abbreviation corresponding to the category.

32. The method of claim 31, further comprising the step of:
providing the domain name with at least one of a hyphen, a prefix, and a suffix.

33. The method of claim 31, wherein the prefix or suffix is selected from the group consisting of a letter, a term, and a number.

34. The method of claim 25, further comprising the step of providing the websites with a plurality of links.

35. The method of claim 34, wherein the links are internal to the information network.

36. The method of claim 34, wherein the links originate from outside the information network.

37. The method of claim 25, further comprising the step of:
providing a search engine.

38. The method of claim 25, further comprising the step of:
providing the website with at least one of promotional information and advertising information.

39. The method of claim 25, further comprising the step of:
providing the website with at least one of product information and service information.

40. The method of claim 25, further comprising the step of:
providing at least one information directory comprising at least one of a site map and a plurality of links to the websites.

41. The method of claim 25, wherein the websites and domain names are arranged in a hierarchical structure.

42. The method of claim 25, farther comprising the step of:
providing at least one matrix of information.

43. The method of claim 25, wherein the information network is deployed by a single entity.

44. The method of claim 25, wherein the information network is deployed by a single entity and at least one an additional entity.

45. The method of claim 25, further comprising the step of:
providing additional domain names for future use.

46. The method of claim 25, further comprising the step of:
providing at least one mirror website.

47. The method of claim 25, further comprising the step of:
receiving registration information from a user, the registration information comprising at least one of a user name, an e-mail address, a mailing address, a URL, and a password.

48. A method for enhancing a probability of high placement of a webpage by a search engine, comprising:
providing the website with a plurality of links;
providing the website with a domain name corresponding to a category of the website; and
providing the website with content containing key words related to the category.

47. The method of claim 48, wherein the step of providing the website with a domain name corresponding to a category of the website comprises:
providing the domain name with a top-level domain; and
providing the domain name with at least one of a descriptive term, a simple term, and an abbreviation corresponding to the category.

48. The method of claim 49, wherein the step of providing the website with a domain name corresponding to a category of the website further comprises:
providing the domain name with at least one of a hyphen, a prefix, and a suffix.

49. The method of claim 50, wherein the prefix or suffix is selected from the group consisting of a letter, a term, and a number.

50. The method of claim 48, wherein the links are internal to a network in which the website exists.

51. The method of claim 48, wherein the links originate externally to a network in which the website exists.
